(19) United States
(12) Patent Application Publication
(10) Pub. No.: US 2010/0138318 A1
(43) Pub. Date: Jun. 3, 2010

(54) Method For Estate Transaction By Network of Member Store

(76) Inventor: Myong-sun Chun, Seoul (KR)

Correspondence Address: THORPE NORTH & WESTERN, LLP., P.O. Box 1219, SANDY, UT, 84091-1219, US

(21) Appl. No.: 12/631,545

(22) Filed: Dec. 4, 2009

Related U.S. Application Data
(62) Division of application No. 10/564,217, filed on Jan. 6, 2006.

(30) Foreign Application Priority Data
Jul. 9, 2003 (KR) 10-2003-0046401

(51) Int. Cl. G06F 15/16; G06Q 30/00; G06Q 50/00; G06F 17/30; G06F 3/048

(52) U.S. Cl. 705/27; 715/738; 707/769; 707/E17.014

(57) ABSTRACT

Since conventional real estate portal sites are one-directionally provided by real estate portal site operators, wrong information may be provided. Also, since a large amount of real estate information must be frequently provided and changed, material and human resources must borne. Also, customers must visit corresponding real estate agents in order to obtain detailed information on the real estate they want after obtaining information on real estate through the Internet unless direct dealings are performed. It is an object of the present invention to provide a real estate information providing method through the network of member stores capable of letting sellers of real estate select whether to directly deal in the real estate through the Internet or to deal in the real estate through real estate agents connected to each other by network and of letting purchasers of real estate obtain detailed information on the real estate for sale through accessible member stores to deal in the real estate when the purchasers deal in the real estate through the member stores. It is another object of the present invention to provide a method of providing real estate information through the network of member stores in which member stores are classified by levels or regions to provide real estate information restricted by the levels or the regions of the member stores when the real estate for sale is requested to be searched.

### CROSS-REFERENCE TO RELATED APPLICATIONS AND CLAIM OF PRIORITY

This is a divisional of U.S. patent application Ser. No. 10/564,217 filed on Jan. 6, 2006, which claims priority to PCT patent application No. PCT/KR2004/001694 filed on Jul. 9, 2004, which claims priority to Korean patent application No. 10-2003-0046401 filed on Jul. 9, 2003.

### TECHNICAL FIELD

The present invention relates to a method of providing information on real estate and of dealing in real estate, and more particularly, to a real estate information providing method through the network of member stores capable of letting sellers of real estate select whether to directly deal in the real estate through the Internet or to deal in the real estate through real estate agents connected to each other by network (hereinafter, referred to as member stores), of providing detailed information on the real estate for sale through the member stores to deal in the real estate through the member stores when the sellers deal in the real estate through the member stores, and of providing information on real estate in accordance with the levels of the member stores.

### BACKGROUND ART

In general, dealing in real estate is activated through the Internet. Large real estate agents provide a large amount of real estate information to real estate customers through their own home pages on the Internet.

Also, real estate portal sites for providing all information on real estate such as financial information such as real estate purchase and sale, lease, and advance for real estate purchase regardless of regions are operated.

However, since such conventional real estate portal sites are one-directionally provided by real estate portal site operators, wrong information may be provided. Also, since a large amount of real estate information must be frequently provided and changed, material and human resources must borne.

Also, customers must visit corresponding real estate agents in order to obtain detailed information on the real estate they want after obtaining information on real estate through the Internet unless direct dealings are performed.

### TECHNICAL PROBLEM

It is an object of the present invention to provide a real estate information providing method through the network of member stores capable of letting sellers of real estate select whether to directly deal in the real estate through the Internet or to deal in the real estate through real estate agents connected to each other by network (hereinafter, referred to as member stores) and of letting purchasers of real estate obtain detailed information on the real estate for sale through accessible member stores to deal in the real estate when the purchasers deal in the real estate through the member stores.

It is another object of the present invention to provide a method of providing real estate information through the network of member stores in which member stores are classified by levels or regions to provide real estate information restricted by the levels or the regions of the member stores when the real estate for sale is requested to be searched.

### TECHNICAL SOLUTION

In order to achieve the first object, there is provided a method of dealing in real estate through network of member stores, the method comprising a seller connecting step of, when a seller or a member store connecting a real estate dealing server through a terminal and requests to sell real estate, a real estate dealing server displaying a real estate for sale information input window on the terminal of the seller or the member store, a real estate for sale registering step of storing data input to the respective information input fields displayed on the real estate for sale information input window in a real estate information database of the real estate dealing server after the seller connecting step, and a real estate for sale information providing step of, when a purchaser or a member store connects a real estate dealing server through a terminal and requests to purchase real estate, the real estate dealing server displaying real estate for sale information and modes of dealing registered in the real estate information database on the terminal of the purchaser or the member store.

In order to achieve the second object, there is provided a real estate information providing method through the network of member stores of connecting the Internet using a terminal of a seller who tries to sell real estate to register information on real estate for sale in a real estate dealing server and to request terminals of real estate member stores to provide information on real estate for sale such that the information on the real estate for sale registered in the real estate dealing server is provided through the terminals of the member stores. The real estate information providing method comprises a member store log in step of connecting the real estate dealing server to request a member store to log in, a member store registration step of, when it is determined that the member store is not registered, registering the member store in accordance with search conditions of member stores, a real estate for sale search window display step of, when it is determined that the member store terminal is logged in, transmitting a real estate for sale search window to the member store terminal such that the real estate for sale search window is displayed, a member store search condition determining step of determining the set search conditions of the member store in accordance with the search request input through the real estate for sale search window, and a real estate for sale detailed information providing step of accessing detailed information on real estate for sale from a real estate information database in accordance with the search conditions of the member store to transmit the detailed information to the member store terminal.

### ADVANTAGEOUS EFFECTS

As described above, according to the method of dealing in real estate through the network of member stores of the present invention, when a seller tries to sell real estate through the Internet, the seller selects direct dealing or dealing through intermediation and directly inputs real estate for sale so as to make information on real estate for sale clear. When a purchaser tries to purchase the real estate for sale selected to be dealt in through intermediation, the corresponding real estate for sale is dealt in by any member stores registered as members such that dealings can be made without visiting determined real estate agents to reduce dealing steps and to thus reduce economic and temporal loss.

Also, since information on the real estate for sale is classified by the kinds of real estate and dealing and member stores select any kinds of real estate and dealing to provide information on the real estate for sale within the selected kinds of real estate and dealing, it is possible to specialize, subdivide, and diversify member stores.

### BRIEF DESCRIPTION OF THE DRAWINGS

The objects and advantages of the present invention will be more clearly understood with reference to accompanying drawings and detailed description of the preferred embodiment below.

FIG. 1 is a block diagram of a real estate information providing network according to the present invention;

FIG. 2 is a flowchart illustrating processes of dealing in real estate through the network of member stores according to an embodiment of the present invention;

FIG. 3 illustrates a real estate for sale input window displayed on a seller terminal according to the embodiment of the present invention;

FIG. 4 illustrates a list of real estate for sale displayed on a purchaser terminals according to the embodiment of the present invention;

FIG. 5 illustrates a list of real estate for sale displayed on a member store terminal according to the embodiment of the present invention;

FIG. 6 is a flowchart illustrating processes of dealing in real estate through the network of member stores according to another embodiment of the present invention; and

FIG. 7 illustrates an input window for selecting kinds of real estate, dealing kinds, and regions that can be selected by member stores according to another embodiment of the present invention.

### BEST MODE FOR CARRYING OUT THE INVENTION

Embodiments of the present invention will be described in detail with reference to the attached drawings.

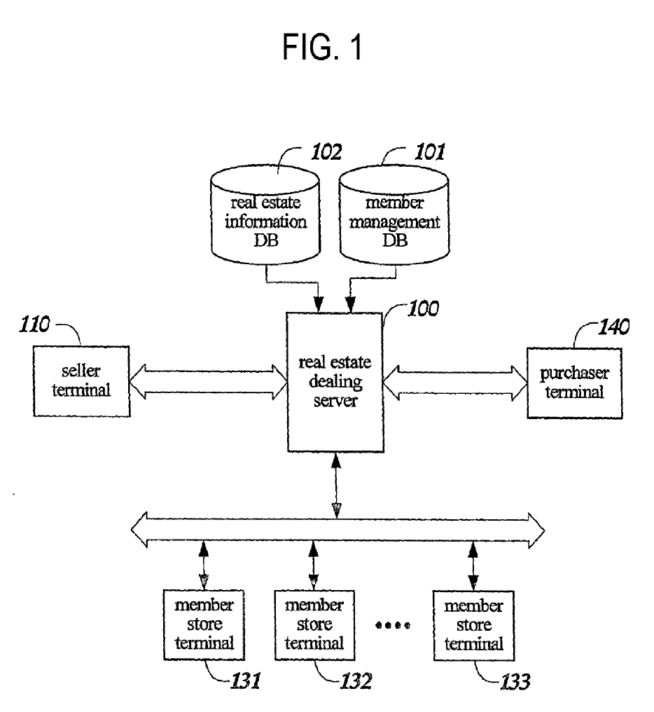

FIG. 1 is a block diagram of a system of dealing in real estate through the network of member stores according to the present invention. The system includes a seller terminal 110 for selling real estate through the Internet, a purchaser terminal 140 for searching information on real estate for sale in order to purchase real estate through the Internet, a plurality of member store terminals 131 to 133 connected to each other through network in order to deal in real estate for sharing real estate information through network to provide detailed information on real estate and sellers registered by sellers in accordance with the request of purchasers, and a real estate dealing server 100 for storing information on real estate for sale registered by the seller terminal 110 in a real estate information database 102, for providing information on real estate for sale registered in the real estate information database 102 in accordance with the search request by the purchaser terminal 140, and for providing non-published information that is not provided to common purchasers in accordance with the request to search information on real estate for sale by the member store terminal 131.

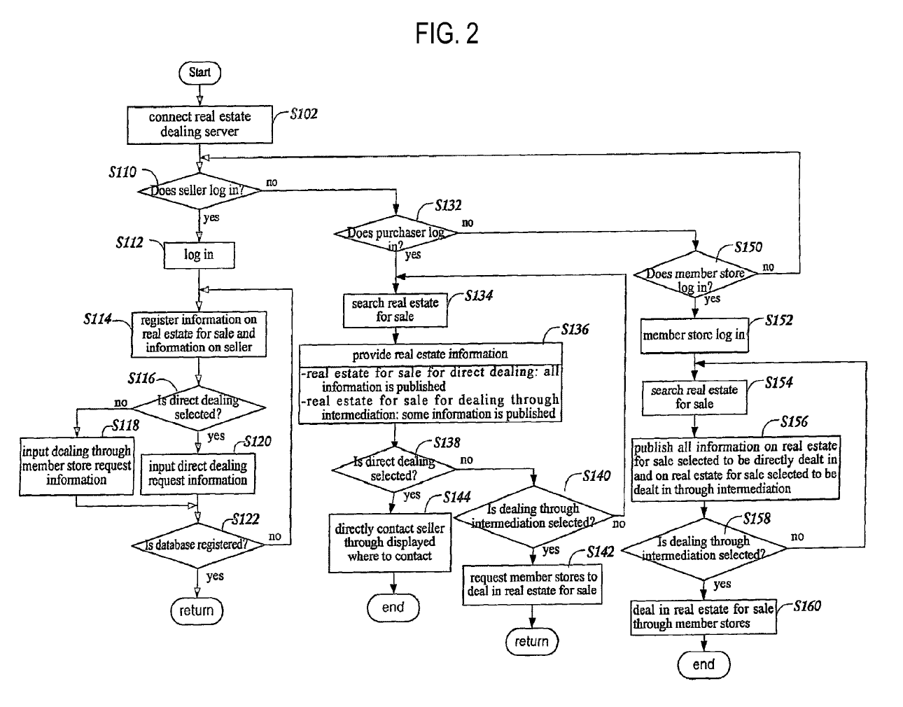

Hereinafter, a method of dealing in real estate through the network of member stores according to an embodiment of the present invention will be described in detail with reference to FIGS. 1 and 2.

FIG. 1 is a block diagram of network for dealing in real estate according to the present invention. FIG. 2 is a flowchart illustrating a method of dealing in real estate through the network of member stores according to an embodiment of the present invention.

As illustrated in FIG. 2, according to the present invention, a seller connects a real estate dealing server 100 through the seller terminal 110 in order to sell real estate (S102).

The real estate dealing server 100 requests the seller terminal 110 to log in through a home page (S110).

Information on members input by the seller terminal 110 is searched from a member management database (DB) 101 to perform log in (S112).

When the seller performs log in through the seller terminal 110 and selects real estate for sale, a sale information input window required for registering real estate for sale is transmitted from the real estate dealing server 100 to the seller terminal 110.

The seller inputs information on the real estate for sale and where to contact such as a telephone number in the respective fields of the input window displayed on the seller terminal 110 (S114).

At this time, the seller selects a mode of dealing such as direct dealing and dealing through intermediation (S116).

When the seller wishes to directly deal in the real estate with a purchaser, information required for direct dealing is input.

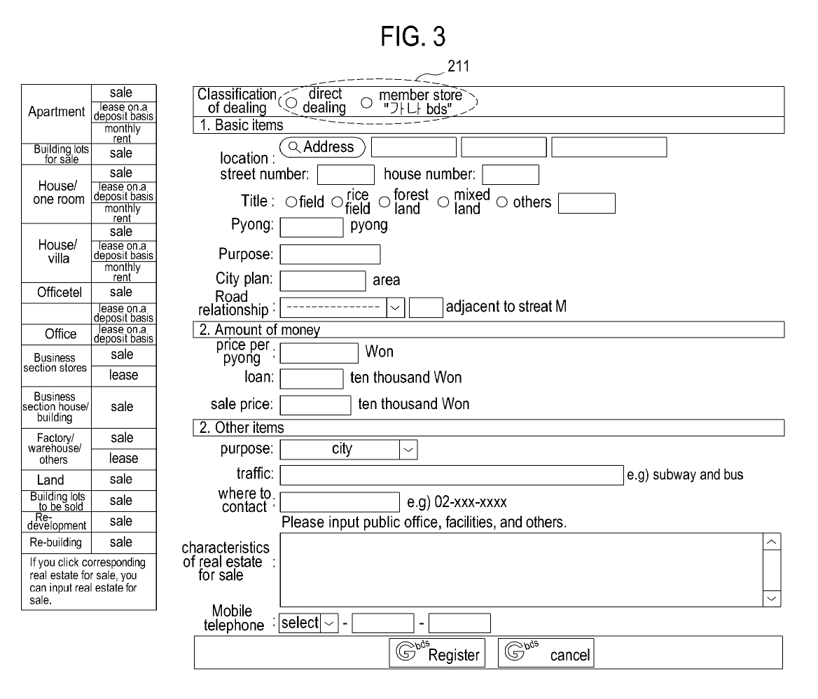

FIG. 3 illustrates the real estate for sale input window displayed on the seller terminal 110. As illustrated in FIG. 3, a direct dealing request column is selected from the dealing mode select window 211 displayed in a predetermined region of the input window (S120).

However, when the seller wishes to deal in the real estate through the intermediation of member stores, dealing through intermediation (bds) is selected (S118).

As described above, when the seller completes to input information through the seller terminal 110 and selects a database registration request key, the real estate dealing server 100 receives the database registration request key and completes to register the database registration request key in the real estate information DB 102 (S122).

The information on the real estate for sale registered in the real estate information DB 102 is provided to the purchaser terminal 140 or the member store terminals 131 to 133 that connect the real estate dealing server 100 through the Internet to search the information on the real estate for sale.

When the real estate purchaser connects the real estate dealing server 100 through the purchaser terminal 140 to request to search real estate for sale, the currently registered list of real estate for sale is transmitted to the purchaser terminal 140 (S132).

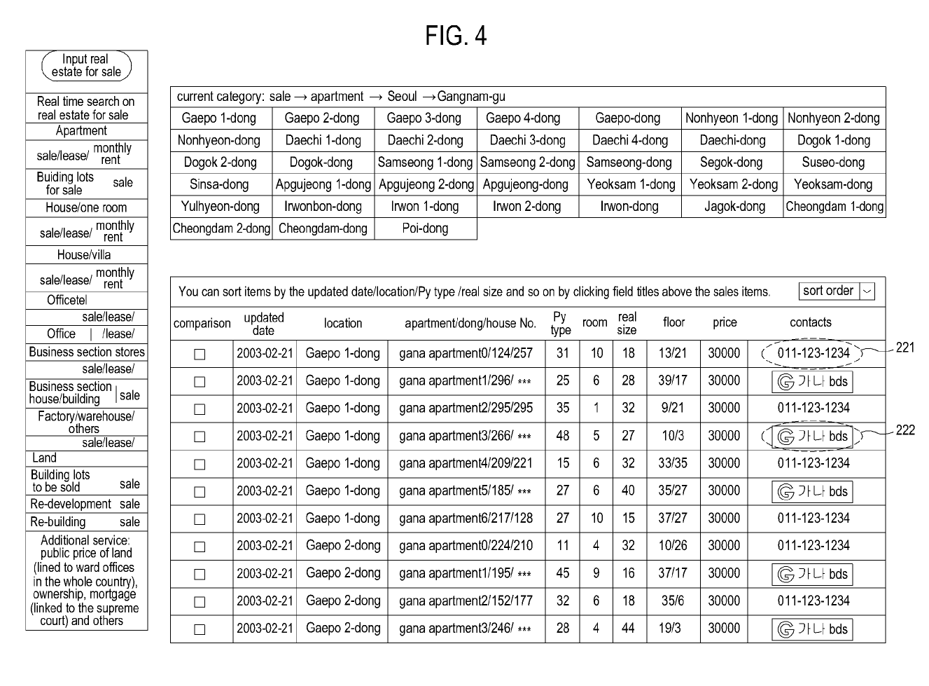

FIG. 4 illustrates a real estate for sale list display window displayed on the purchaser terminal 140. As illustrated in FIG. 4, in the case of the real estate selected to be directly dealt in by a seller in the list of the real estate for sale, all information such as information on the real estate such as the address of the real estate for sale required for the direct dealing and where to contact 221 of a real estate for sale register must be displayed.

However, in the case of the real estate for sale selected to be dealt in through intermediation by a seller, only some information is published (S136).

That is, a certain part of the address is not published in the real estate for sale address display window and it is displayed on the seller where to contact display window that the real estate needs to be dealt in through intermediation 222.

As described above, in the case of the real estate for sale selected to be directly dealt in, a purchaser contacts the seller through where to contact to directly deal in the real estate for sale (S138 and S144).

However, in the case of the real estate for sale selected to be dealt in through intermediation as displayed on the purchaser terminal 140, a purchaser requests the registered member stores to intermediate the dealing to perform the dealing (S140 and S142).

As described above, in the case of the real estate for sale selected to be dealt in through intermediation, the dealing proceeds through member stores. The purchaser contacts the member stores registered in the real estate dealing server 100 to deal in the corresponding real estate for sale in order to deal in the real estate selected to be dealt in through intermediation.

A predetermined member store searches real estate for sale through its own member store terminal 131 in accordance with the request of the purchaser who wishes to deal in real estate for sale.

First, the member store terminal 131 connects the real estate dealing server 100 through the Internet.

The member store is requested to perform log in as a member in accordance with the guide of the home page provided by the real estate dealing server 100 (S152).

The real estate dealing server 100 searches the member management DB 101 to perform log in.

When it is requested to search real estate for sale by the member store terminal 131 that completed the log in of the member, the current list of the real estate for sale is transmitted to the member store terminal 131 (S154).

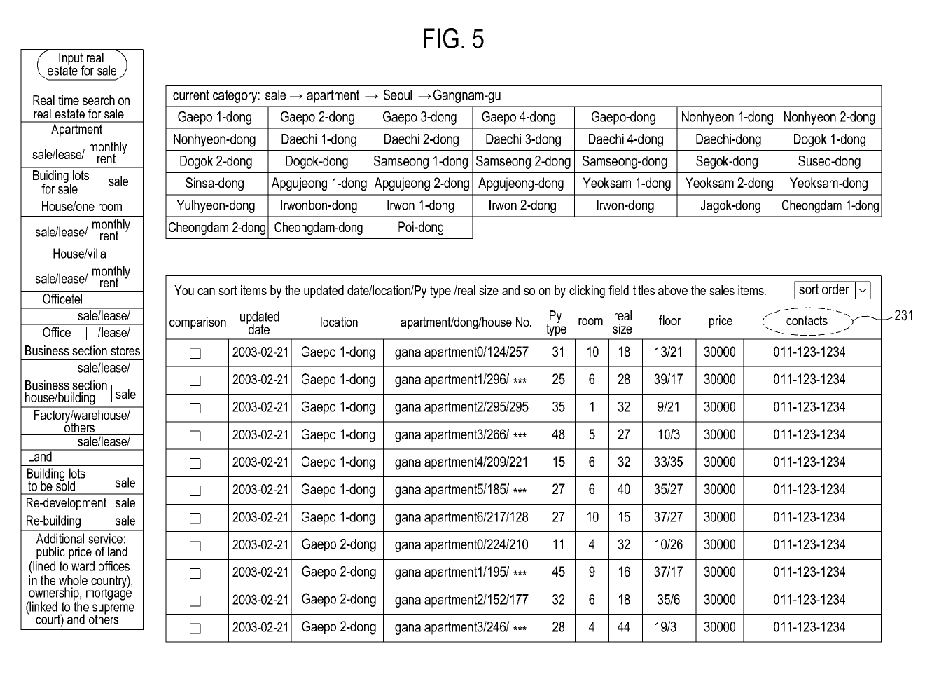

FIG. 5 illustrates a list of real estate for sale displayed on a member store terminal. As illustrated in FIG. 5, the list of the real estate for sale displayed on the member store terminal 131 displays both information on the real estate for sale and information on the seller input by the seller (S156).

At this time, where to contact of the seller is displayed on a seller where to contact display window 231 and it is displayed that the where to contact of the seller is not to be published to common purchasers in accordance with intermediation of dealing in a certain region.

On the other hand, only the real estate for sale selected to be dealt in through member stores are displayed.

A purchaser deals in the real estate for sale using the real estate information and the where to contact of the seller provided by the member store terminal 140 of the corresponding member store (S153 and S160).

As described above, when the real state for sale the purchaser searched is selected to be dealt in through intermediation, the purchaser searches detailed information on the real estate for sale using the terminal of any member store registered as a member to proceed dealing.

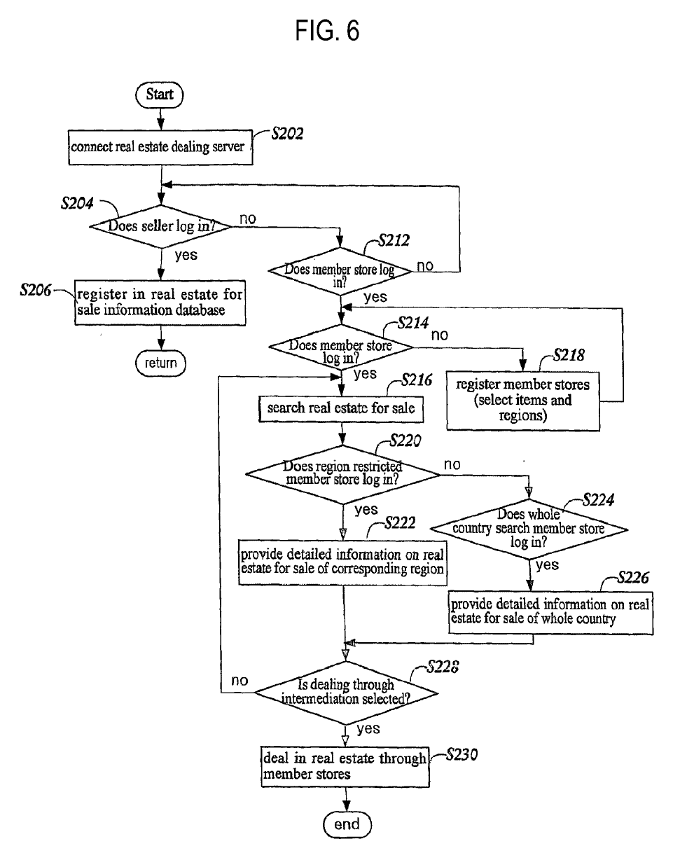

A method of dealing in real estate through the network of member stores according to another embodiment of the present invention will be described in detail with reference to FIG. 6.

FIG. 6 is a flowchart illustrating processes of dealing in real estate through the network of member stores according to another embodiment of the present invention. A seller of real estate connects the real estate dealing server 100 through the seller terminal 110 and inputs information on the real estate for sale to register the information in the real estate information DB 102 (S202 to S206).

At this time, the real estate information registered through the seller terminal 110 is necessarily provided by the registered member store terminals 131 to 133.

That is, detailed information on the registered real estate for sale is not displayed and only rough information is displayed on the purchaser terminal 140 of a purchaser who wishes to purchase the real estate. Thus, in order to obtain detailed information on the real estate he or she wishes to deal in and to deal in the real estate, he or she must visit a registered member store for dealing in the real estate to request the detailed information on the real estate and to deal in the real estate.

The member store connects the real estate dealing server 100 through the member store terminals 131 to 133 in accordance with the request of the purchaser to perform log in (S202 to S214).

A member store that is not registered is registered as a member store (S218).

In order to be registered as a member store, an input window is transmitted from the real estate dealing server 100 to the corresponding member store terminals 131 to 133 such that basic information on the member store is input and that the kind, the item, and the region of the real estate for sale is selected for the dealing service of the member store.

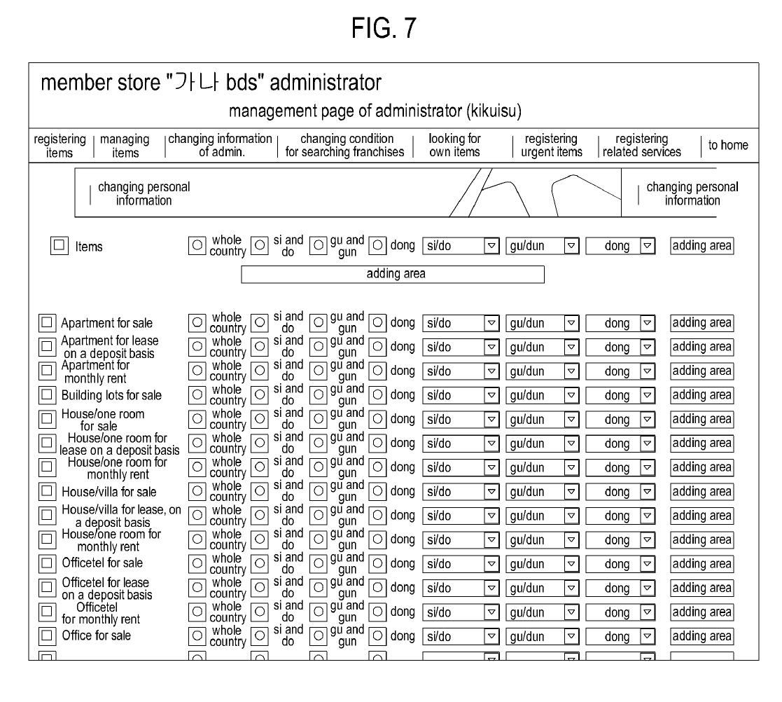

FIG. 7 is illustrates an input window provided for a member store to select the kind, the mode of dealing, and the region of the desired real estate.

As illustrated in FIG. 7, the member store can select various real estate items such as apartment, villa/house, building lots for sale, officetel, and land in accordance with the mode of dealing such as sale, lease of a house on a deposit basis, and monthly rent and can select a service region among the whole country, si and do, gu and gun, and dong such that member stores are classified to provide subdivided and various services.

As described above, the corresponding member store selected to serve provides detailed information on the real estate for sale and dealing services under the selected search conditions.

That is, when a member store connects the real estate dealing server 100 through the member store terminals 131 to 133 and searches real estate for sale in accordance with the request of a purchaser, the real estate dealing server 100 searches information on the real estate for sale through the real estate information DB 102 under the search conditions of the corresponding member store terminals 131 to 133 (S216 to S226).

When restriction on regions is selected as a search condition, only information on real estate for sale in the selected region is provided. When restriction on items is selected as a search condition, only the corresponding item is searched to provide detailed information on the item (S220 and S222).

When a member store is registered to search the whole country, detailed information on the real estate for sale in the whole country is provided to the member store terminals 131 to 133. At this time, when restriction on items is selected, only the kind of the corresponding real estate and the mode of dealing are searched to be provided to the purchaser (S224 and S226).

The information on the real estate for sale that the real estate information DB 102 accesses is transmitted to the corresponding member store terminals 131 to 133 to be published to common purchasers.

As described above, the information on the real estate for sale published to common purchasers through the corresponding member store terminals 131 to 133 is provided to the purchaser such that dealing of the real estate for sale the purchaser desires is performed (S228 and S230).

What is claimed is:

1-9. (canceled)

10. A method at a real estate dealing server for dealing real estate information through a communication network in which a member store terminal, a seller terminal and a purchaser terminal are communicatively connected to the real estate dealing server, wherein the real estate dealing server includes a real estate information database storing a plurality of real estate identifications, comprising:
receiving a real estate registration request from the seller terminal or the member store terminal;
transmitting an input window for prompting an entry of registration information including real estate information, dealing mode information and seller information to the seller terminal or the member store terminal;
receiving the registration information;
storing the registration information in the real estate information database as a real estate identification;
receiving a real estate search request including at least one search condition from the purchaser terminal;
searching the real estate information database to find at least one real estate identification satisfying the search condition;
checking whether the dealing mode information in the found real estate identification indicates a direct dealing mode or an intermediation dealing mode; and
if it is determined that the dealing mode information indicates the intermediation dealing mode, transmitting a limited portion of the registration information in the found real estate identification to the purchaser terminal, said limited portion of the registration information including limited real estate information and limited seller information.

11. The method of claim 10, further comprising:
receiving a real estate search request including at least one search condition from the member store terminal;
searching the real estate information database to find at least one real estate identification satisfying the search condition; and
transmitting the registration information in the found real estate identification to the member store terminal.

12. The method of claim 11, further comprising:
checking whether the dealing mode information in the found real estate identification indicates a direct dealing mode or an intermediation dealing mode; and
transmitting display data to display the dealing mode information in a predetermined region on the member store terminal if it is determined that the dealing mode information indicates the intermediation dealing mode.

13. The method of claim 11, wherein the registration information transmitted to the member store terminal is determined based on a registration level related to the member store terminal.

14. The method of claim 11, wherein the registration information transmitted to the member store terminal is determined based on a registration search condition related to the member store terminal.

15. The method of claim 14, wherein the registration search condition includes a region of the real estate, a kind of the real estate, and the dealing mode information.

16. A method at a real estate dealing server for dealing real estate information through a communication network in which a member store terminal and a seller terminal are communicatively connected to the real estate dealing server, wherein the real estate dealing server includes a real estate information database storing a plurality of real estate identifications, comprising:
receiving a connection request including a log-in information;
checking whether the connection request is transmitted from a member store terminal or a seller terminal based on the log-in information;
if it is determined that the connection request is transmitted from the seller terminal, admitting the seller terminal to proceed to a real estate registration mode; and
if it is determined that the connection request is transmitted from the member terminal, admitting the member terminal to proceed to a real estate search mode instead of the real estate registration mode;
wherein the real estate registration mode comprises:
transmitting an input window for prompting an entry of registration information including real estate information, dealing mode information and seller information to the seller terminal;
receiving the registration information;
storing the registration information in the real estate information database as a real estate identification, and
the real estate search mode comprises:
receiving a real estate search request including at least one search condition from the member store terminal;
searching real estate information database to find at least one real estate identification satisfying the search condition;
transmitting the registration information in the found real estate identification to the member store terminal, and
the dealing mode information includes information indicating whether real estate to be registered is for sale or for rent, and a building or land.

17. A method at a real estate dealing server for dealing real estate information through a communication network in which a member store terminal and a seller terminal are communicatively connected to the real estate dealing server, wherein the real estate dealing server includes a real estate information database storing a plurality of real estate identifications, comprising:
receiving a connection request including a log-in information;
checking whether the connection request is transmitted from a member store terminal or a seller terminal based on the log-in information;
if it is determined that the connection request is transmitted from the seller terminal, admitting the seller terminal to proceed to a real estate registration mode;
if it is determined that the connection request is transmitted from the member terminal, checking whether the member terminal is registered or not;
if it is determined that the member terminal is registered, admitting the registered member terminal to proceed to a real estate search mode instead of the real estate registration mode;
if it is determined that the member terminal is not registered, admitting the member terminal to proceed to a member registration mode instead of the real estate registration mode and the real estate search mode, and
wherein the real estate registration mode comprises:
transmitting an input window for prompting an entry of registration information including real estate information, dealing mode information and seller information to the seller terminal;
receiving the registration information;
storing the registration information in the real estate information database as a real estate identification, and
the member registration mode comprises:
transmitting an input window for prompting an entry of member registration information including a registration search condition to the member terminal;
receiving the member registration information;
storing the member registration information in the real estate information database; and
the real estate search mode comprises:
receiving a real estate search request including at least one search condition from the registered member store terminal;
searching the real estate information database to find at least one real estate identification satisfying the search condition; and
transmitting the registration information in the found real estate identification to the registered member store terminal.
